(19) United States
(12) Patent Application Publication
(10) Pub. No.: US 2002/0174203 A1
(43) Pub. Date: Nov. 21, 2002

(54) Method of forwarding data packets in communications-network routers

(75) Inventors: Edgar Wolfram Kuhn, Stuttgart (DE); Harald Eckhardt, Stuttgart (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/139,390

(22) Filed: May 7, 2002

(30) Foreign Application Priority Data
May 18, 2001 (DE) 101 24 706.0

(51) Int. Cl. G06F 7/00

(52) U.S. Cl. 709/220

(57) ABSTRACT

The invention relates to a method of forwarding data packets in communications-network routers, in particular of forwarding data packets according to the Internet Protocol (IP) in radio-based access networks. A context identifier (CID1) of a received data packet is evaluated. By means of a table, a communications link (LINK15) assigned to said context identifier (CID1) is found for forwarding the data packet. The data packet is emitted via the communications link (LINK15) found.

### BACKGROUND OF THE INVENTION

The invention relates to a method of forwarding data packets in communications-network routers, in particular of forwarding data packets according to the Internet Protocol in radio-based access networks.

The invention is based on a priority application DE 101 24 706.0 which is hereby incorporated by reference.

### SUMMARY OF THE INVENTION

Methods of the above-mentioned type are known and are used, for example, for routing in so-called mobile-radio system routers. The transmission of data packets according to the Internet Protocol (IP) via such mobile-radio systems is likewise known. Such data packets are described below as IP packets.

The methods corresponding to the prior art often apply the header-compression method to IP packets in order to improve the protocol efficiency, especially in the case of communications connections (termed “links” below) having low bandwidth. The header-compression method comprises two steps within a router, namely the decompression of the data after receipt and the recompression for forwarding the data to the next router. These two steps are very computationally exacting and time-consuming since a hardware implementation has hitherto been very expensive because of its complexity. The precise mode of operation of the header compression is explained in the description relating to FIG. 1 by reference to an example.

A disadvantage of the application of header compression in the methods corresponding to the prior art is the need to decompress a received IP packet within a router, which only has to forward the IP packet, but is not defined as the target of said IP packet. This decompression is necessary for the correct forwarding of the IP packet, which is based, inter alia, on a routing method that requires the terminal address of the IP packet to be forwarded as an input variable.

Particularly time-consuming is the routing method since it requires processing of the protocol data up to layer 3 of the ISO/OSI basic reference model. This also involves, in particular, the decompression and compression steps.

After performing the routing method, in the hitherto known methods of the generic kind, the IP packet is recompressed and then transmitted to the next router or target host.

In total, therefore, if header compression is applied, three steps are necessary within a router in order to forward an IP packet, each of which is very time-consuming. In regard to an efficient utilization of the resources of the communication network, this is particularly disadvantageous since a very high computational expenditure is necessary for a single packet within a router. Especially in the case of packets containing little user data, in particular, for example in the case of speech, the bandwidth efficiency and the packet transmission time are impaired as a result.

Accordingly, the object of the invention is to develop a method of forwarding data packets further in such a way that the forwarding of the data packets can be achieved with lower time and technical expenditure.

According to the invention, this object is achieved in that a context identifier (Context IDentifier, CID for short) of a received data packet is evaluated, in that a communications link assigned to said context identifier is found by means of a table, and in that the data packet is emitted via the communications link found.

According to the invention, therefore, the CID is transmitted together with the IP packets subjected to header compression and can be evaluated by a router without decompression. The decompression, routing and compression steps necessary in the prior art are unnecessary.

To apply said method, a first router or host has to find a free CID1 and transmit a first IP packet not subjected to header compression together with said CID1 to a second router. On receipt of said IP packet having the hitherto unused CID1, the second router performs a routing method and finds a subsequent router to which the IP packet has to be forwarded. The second router then makes a new entry in a table managed by it, which entry contains the CID1 of the IP packet and the number of the link via which the second router transmits the IP packet to the next router. The second router then selects in turn a CID2 for the IP packet and transmits it without header compression and together with said CID2 to the next router.

The CID2 and also the number of the link via which the second router has received the IP packet from the first router supplement the table entry mentioned of the second router. Said table entry assigns another value pair comprising CID2 and associated output link to a value pair comprising CID1 and associated input link. The table consequently provides, in a certain manner, a special type of routing information.

A second IP packet is subjected to header compression in the first router and transmitted, together with the CID1 already found for the first IP packet to the second router. On receipt of the second IP packet on the same input link as before, the second router searches for the value pair comprising input link and CID1 of the second IP packet in the table and finds the associated value pair comprising output link and CID2. The second router consequently does not have to perform any of the three steps, mentioned at the outset, of decompression, of routing and of recompression. Instead, the second router can forward the IP packet immediately with the CID2 on the output link. The forwarding consequently takes place only through a search for a table entry that can be executed very rapidly and is simple to implement.

It is particularly advantageous if the so-called context identifier known from the IETF protocol RFC 2507 is used as context identifier and if a transformation of the value range of the context identifier is undertaken in order to avoid a value collision and in order to make possible an unambiguous assignment of received IP packets to the packet data streams comprising them. This embodiment ensures compatibility with conventional methods in which the decompression step is undertaken after every transmission from one router to the next router and the IP address of the destination is consequently found.

An advantageous development of the method according to the invention envisages that a received compressed IP data or compressed header data of a received IP packet is decompressed for the purpose of error detection and/or error correction.

As soon as a discrepancy is detected between the decompressed information of the received IP packet and the items of information stored in the table, the IP packet can be requested via a return channel in decompressed form as a so-called “full-header” packet.

The decompression may be executed in selected routers situated between transmitter and target host of the IP packet or, alternatively, be executed only in the target host.

### BRIEF DESCRIPTION OF THE DRAWINGS

Further features, possible applications and advantages of the invention emerge from the description given below of exemplary embodiments of the invention that are shown in the figures of the drawing. In the latter, all the features described or shown form, separately or in any combination, the subject matter of the invention, regardless of whether they are recapitulated in the patent claims or in the back references of the latter and also regardless of their formulation or presentation in the description or in the drawing.

In the drawing:

FIG. 1 shows a diagrammatic representation of a radio-based access network having a plurality of routers in which the method according to the invention is applied, and

FIG. 2 shows a table for use in one of the routers that reflects the correlation of context identifiers with communications links.

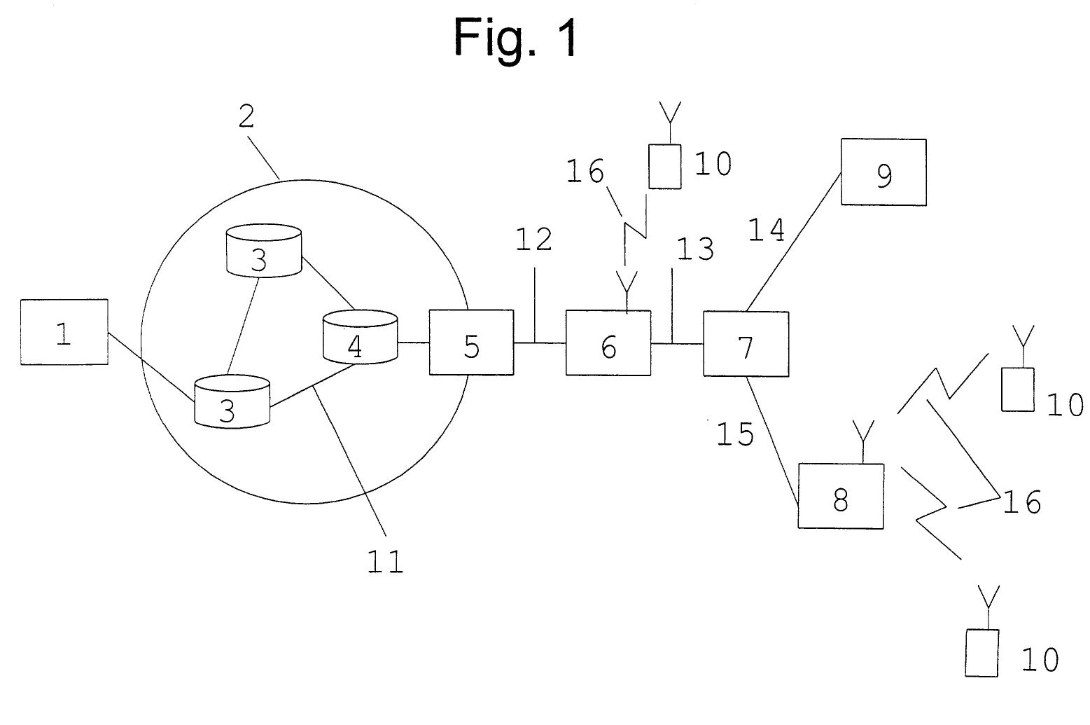

FIG. 1 shows a radio-based access network, a so-called radio-access network (RAN) that can be used, for example, in GSM and UMTS systems for the packet-oriented data transmission by the method according to the invention. The radio-based access network can be divided into a plurality of sections:

a communications network 2 that receives packet data streams from a suitable network element 1,

an intermediate section of the radio-based access network that comprises base stations 6, 7, and

base stations 8, 9 and also mobile communications devices 10.

The communications network 2 comprises at least one network node. In the example according to FIG. 1, three network nodes 3, 4 are shown, of which the network nodes 3 are connected only to network nodes within the communications network 2 or to the network element 1, but the network node 4 also has a link to a communications device 5 outside the communications network 2. The network nodes 3, 4 of the communications network 2 are mutually connected by communications links (described below as links) 11 that make possible a bi-directional data exchange and, for example, may be designed as cable connections or also radio relay paths. The communications device 5, for example a so-called “edge router”, is likewise connected to the network node 4 of the communications network 2 via a link 11.

The intermediate section, comprising the base stations 6 and 7, of the radio-based access network shown is connected to the communications network 2 via the communications device 5 and also the associated communications links.

FIG. 1 furthermore shows a base station 8 via which the mobile communications devices 10 can make a radio connection 16 to the rest of the radio-based access network. Such a radio connection 16 is also possible to the base station 6.

The communications device 5 is connected to the base station 6 via the link 12. The base stations 6, 7 are mutually connected via the link 13, the base stations 7, 9 via a link 14 and the base stations 7, 8 via a link 15. The links 12, 13, 14 and 15 make possible a bi-directional data exchange and, like the links 11, can be designed, for example, as cable connections or also radio relay paths.

The base stations 6 to 9, the network nodes 3, 4 and the communications device 5 are described below as routers since reference is especially made in this description to their routing capability.

The data exchange, considered in this exemplary embodiment, via the links 11, 12, 13, 14, 15 is packet-oriented and based on the Internet Protocol (IP). In said protocol, the data to be exchanged are divided into data packets (IP packets) and transmitted in packets. Such an IP packet comprises user data (payload) and header data (header). The user data contain the information actually to be transmitted and the header data are protocol-specific and, in the case of the Internet Protocol, contain, inter alia, the IP address of the source and of the destination of an IP packet and also further data for controlling the data transmission.

To transmit IP packets, so-called header compression is often used. The method substantially comprises the replacement of the header data of an IP packet by a shorter data set that contains, inter alia, a context identifier (CID). This CID acts as the actual header data of the IP packet. Such CIDs are known, for example, from the IETF (Internet Engineering Task Force) Protocol RFC 2507.

Each of the routers 3 to 9 manages a limited number of CIDs. Each router can find a CID for a new data transmission and can characterize it as seized, while CIDs no longer used can be released again.

A typical data transmission, comprising the IP packets A, B, C . . . , E, from the router 6 to the base station 8, described below as terminal node, will be considered below. In this connection, the main emphasis is placed on the fast forwarding of data packets in the router 7. Cited CIDs are serially numbered (CID1, CID2, . . . ) for the purpose of illustration, but this enumeration is not connected to the actual value of the CID in the respective router.

a) Transmission of the First IP Packet A by the Router 6 to the Router 7.

By applying a routing method, the router 6 finds the link 13 as output link for the transmission of the IP packet A to the router 7. It selects a free CID1, marks said CID1 as seized and transmits the IP packet A, not subjected to header compression, together with the CID1 to the router 7.

b) Reception of the IP Packet A in the Router 7.

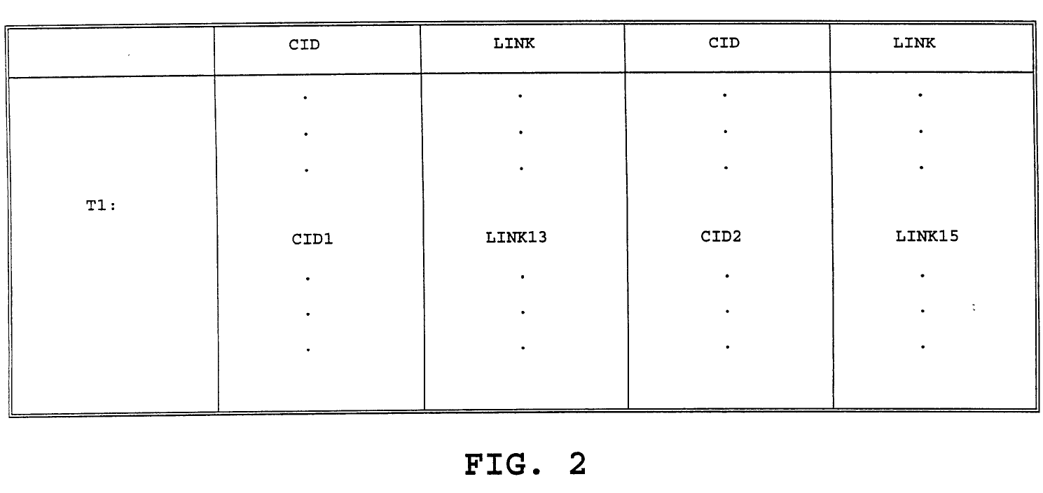

On receipt of the IP packet A, the router 7 detects the fact that a hitherto unused CID1 has been transmitted. It then records a new entry T1 in a table in accordance with FIG. 2.

FIG. 2 shows with reference to router 7 a table, by way of example, for the correlation of context identifiers with links for use in the routers 3 to 7. For this purpose, every entry in the table is given, in addition to further possible data, such as, for example, items of context information from complete header data, at least two value pairs, namely:

CID of the IP packet received on the input link,

input link,

CID of the IP packet transmitted on the output link,

output link.

In the present exemplary embodiment of FIG. 1, the entry in the table of FIG. 2 first comprises only the value of the CID1 and the number of the link 13 via which the IP packet A was received in the router 7.

c) Forwarding of the IP Packet A

Using the terminal address, obtained from the header of the IP packet A, of the IP packet A, the router 7 then performs a routing method, with the result that the link is used as output link for A by the router 7. The number of the link 15 is likewise inserted into the above-mentioned table entry T1. The router 7 now selects, in turn, a CID2 from its stock of free CIDs that is likewise inserted in the table entry T1.

The router 7 then transmits the IP packet A, together with the CID2, to the terminal node 8 via the link 15.

d) Evaluation of the IP Packet A in the Terminal Node 8

Once the IP pocket A has reached the terminal node 8, an address comparison takes place to the effect that forwarding of the IP packet A is unnecessary. As an indication that said data packets are not to be forwarded, a special value not needed for forwarding IP packets can be selected for the value pair containing the information about the output link or another method may be chosen.

e) Transmission of the Second IP Packet B by the Router 6 to the Router 7

Since the same packet data stream is involved as in step a), the router 6 transmits the IP packet B with the same CID, that is to say the CID1, to the router 7. However, the IP pocket B is subjected beforehand to a header compression. As a result, the header data of the IP packet B is replaced by a shorter data set that contains, inter alia, the CID1.

f) Forwarding of the Second IP Packet B by the Router 7 to the Terminal Node 8

With the CID1 value transmitted in the IP pocket B in combination with the number of the input link 13 used, the router 7 con deduce the routing information for the IP packet B from the entry T1 in the table according to FIG. 2. Packet B can immediately be forwarded with the associated CID2 to the terminal node 8 via the corresponding output link 15. Decompression, routing and recompression are unnecessary. It is only in the terminal node 8 that a decompression of the IP pockets or their header data and transfer to higher protocol layers are performed.

The IP packets C, D etc. can be treated in the same way.

The routers 6 and 7 may equally be terminal nodes for certain pocket data streams.

The routers 3, 4 and 5 of the communications network 2 can also apply the method described. This makes possible forwarding of IP packets over a plurality of routers in the entire radio-based access network shown in FIG. 1 without decompression of the IP header, without applying a routing method and without recompression in every individual router between the source and the terminal of the respective IP packet.

A particular advantage of the method is that it can be applied purely locally in one or more routers or network elements having routing function without special monitoring and control information to further routers having to be exchanged via the input and output links.

Consequently, the method described is self-teaching and compatible with routers not having this functionality and transparent to it. On receiving an IP packet subjected to header compression, such a router has to perform the decompression step in order to obtain the IP address, necessary for routing, of the terminal of the IP packet.

In order not to infringe the number scheme of the IETF standard, the CIDs can be converted by suitable transformation of the value range used. The following example describes this mechanism with reference to FIG. 1.

It is assumed that the terminal nodes 8 and 9 transmit IP packets having header compression to the router 7, which is intended to forward them to the router 6. Since the routers have only a limited number of CIDs and the value range extends upwards at least currently from 0 or 1 for practical reasons, the case may occur that both the router 8 and the router 9 transmit to the router 7 an IP packet D or E having CID3 accidentally selected by them as identical. In the router 7, only the information about the respective input link 15 or 14 can then be used to distinguish the origin of the IP packets D and E. Said information is also utilized for the mentioned transformation of the value range so that, on receipt of the IP packets D and E, the router 6 can distinguish their origin. If the CID3 has, for example, the value 8, the router 7 adds, on receipt of the IP packets D and E, an offset value of, for example, 120 to the value of the CID3 of IP packet E, thereby producing a CID4 having the value 128. The value of CID3 of the packet D is not altered and consequently is always still 8. The router 6 is now able to distinguish the IP pockets D and E in regard to their origin, but only, of course, assuming that the offset value is greater than the value range for CIDs of the corresponding router.

1. Method of forwarding data packets in communications-network routers, in particular data packets according to the Internet Protocol in radio-based access networks, the method comprising the following steps:
evaluation of a context identifier of a received data packet,
finding a communications link assigned to said context identifier by means of a table,
emission of the data packet via the communications link found.

2. Method according to claim 1, comprising the following further step:
finding, by means of the table, a context identifier for the data packet to be emitted via the communications link found.

3. Method according to claim 1, comprising the following further step:
finding the communications link for the data packet to be emitted and/or the context identifier of the data packet to be emitted depending on the communications link of the received data packet.

4. Method according to one of claims 1, wherein the so-called context identifier known from the IETF Protocol RFC 2507 is used as context identifier.

5. Method according to claim 4, wherein a transformation of the value range of the context identifiers is undertaken in order to avoid a value collision and in order to make possible an unambiguous assignment of received data packets to the packet data streams comprising them.

6. Method according to claim 1, comprising the following further steps:
a first data packet is decompressed, but is dispatched with a context identifier,
subsequent data packets of the same data transmission are compressed and dispatched with the same context identifier.

7. Method according to claim 6, comprising the following further steps if a 5 first data packet is received:
entry of a new context identifier in the table,
finding of the communications link for the data packet to be transmitted depending on the decompressed data packet,
entry of the communications link found in the table.

8. Method according to claim 7, comprising the following further steps:
entry of the context identifier of the received data packet and/or of the communications link of the received data packet in the table.

9. Method according to claim 6, wherein only the header data of the subsequent data packets are compressed.

10. Method according to claim 6, wherein a received compressed data packet or compressed header data of a received data packet is decompressed for the purpose of error detection and/or error correction.

11. Router for forwarding data packets for a communications network, the router having means for executing a method of forwarding data packets in communications-network routers, in particular data packets according to the Internet Protocol in radio-based access networks, the method comprising the following steps:
evaluation of a context identifier of a received data packet,
finding a communications link assigned to said context identifier by means of a table,
emission of the data packet via the communications link found.

12. Communications network having a router for forwarding data packets, the router having means for executing a method of forwarding data packets in communications-network routers, in particular data packets according to the Internet Protocol in radio-based access networks, the method comprising the following steps:
evaluation of a context identifier of a received data packet,
finding a communications link assigned to said context identifier by means of a table,
emission of the data packet via the communications link found.
